(19) United States
(12) Patent Application Publication
(10) Pub. No.: US 2026/0319453 A1
(43) Pub. Date: Oct. 15, 2026

(54) POCKET MILLING TOOL PATH OPTIMIZATION METHOD BASED ON DIGITAL FILTERING

(71) Applicant: CHENGDU AIRCRAFT INDUSTRIAL (GROUP) CO., LTD., Chengdu (CN)

(72) Inventors: Wenping MOU, Chengdu (CN); Xin GAO, Chengdu (CN); Pengcheng WANG, Chengdu (CN); Renzheng LI, Chengdu (CN); Binli WANG, Chengdu (CN); Guobo ZHAO, Chengdu (CN); Xin SHEN, Chengdu (CN); Weidong LI, Chengdu (CN)

(73) Assignee: CHENGDU AIRCRAFT INDUSTRIAL (GROUP) CO., LTD., Chengdu (CN)

(21) Appl. No.: 19/681,688

(22) Filed: May 19, 2026

Related U.S. Application Data
(63) Continuation of application No. PCT/CN2024/115412, filed on Aug. 29, 2024.

(30) Foreign Application Priority Data
Nov. 20, 2023 (CN) 202311540959.X

(51) Int. Cl. G05B 19/19

(52) U.S. Cl. CPC G05B 19/19; G05B 2219/36214; G05B 2219/49372

(57) ABSTRACT

A pocket milling tool path optimization method based on digital filtering, includes following steps: reading tool path information; discretizing a tool path at a constant interval along a pocket machining tool path to obtain a series of discrete tool position points; calculating a feeding speed at each of the discrete tool position points in each motion axis direction under theoretical conditions, and obtaining a feeding speed variation curve of the tool path; smoothing the feeding speed variation curve of the tool path through a Gaussian filter to obtain a smoothed feeding speed curve; recalculating new tool position points according to a feeding speed of each discrete point on the smoothed feeding speed curve; and combining recalculated discrete points to form an optimized pocket milling machining tool path.

### CROSS-REFERENCE TO RELATED APPLICATIONS

The present application is a continuation application of International Application No. PCT/CN2024/115412, filed on Aug. 29, 2024, which claims priority to Chinese Patent Application No. 202311540959.X, filed on Nov. 20, 2023. The disclosures of the above-mentioned applications are incorporated herein by reference in their entireties.

### TECHNICAL FIELD

The present application relates to the technical field of intelligent manufacturing, and in particular to a pocket milling tool path optimization method based on digital filtering.

### BACKGROUND

The pocket milling is a common method in structural part machining, especially in the field of aircraft structural part manufacturing, where more than 80% of the workload is consumed in pocket milling. High surface quality and minimal machining time are the goals pursued in the generation or optimization of pocket machining tool paths.

For pocket milling, how to optimize the machining tool path at corners is the key to improving machining efficiency and surface quality. At present, many commercial CAM software often fail to solve the corner problem in the generation of pocket tool paths. In response to this problem, many scholars have provided a series of pocket tool path optimization methods to optimize corner machining.

For example, Chinese Patent Publication CN103042262B discloses an integrated finishing method for inner profile corners of groove features, which performs cyclic machining at corners according to the principles of constant contact angle and maximum contact angle to ensure stable cutting force during corner machining. Hyun-Chul (2007) published a paper “Tool path modification for optimized pocket milling” in the International Journal of Production Research, 2007, 45(24), p 5715-5729, disclosing a groove feature machining method that ensures stable cutting force and avoids vibration during machining through stable material removal rate. Banerjee et al. provided a tool path generation algorithm with constant feeding speed and constant cutting force for 2½D pockets in Computers & Industrial Engineering. This algorithm adopts the parallel offset idea and reversely deduces the previous tool path from the last layer tool path to control the actual cutting width, but the tool path is not smooth and continuous enough.

The above methods can optimize the machining tool path to a certain extent, but they do not fully quantitatively analyze the machine tool dynamic response capability, and further optimize the machining tool path based on machine tool dynamic characteristics.

### SUMMARY

To solve the above problems, the present application provides a pocket milling tool path optimization method based on digital filtering, which can make the pocket machining tool path smoother, more adaptable to the acceleration and deceleration characteristics of the machine tool, and improve machining efficiency.

To achieve the above purpose of the application, the technical solution provided by the present application is as follows.

A pocket milling tool path optimization method based on digital filtering includes:
reading tool path information from a pocket machining tool location file or a numerical control (NC) program;
discretizing a tool path at a constant interval ΔS along a pocket machining tool path to obtain a series of discrete tool position points;
calculating a feeding speed at each of the discrete tool position points in each motion axis direction under theoretical conditions according to a given feeding speed of a tool path, and obtaining a feeding speed variation curve of the tool path according to a feeding speed at each of the discrete tool position points;
smoothing the feeding speed variation curve of the tool path through a Gaussian filter to obtain a smoothed feeding speed curve;
recalculating new tool position points according to a feeding speed of each discrete point on the smoothed feeding speed curve; and
combining recalculated discrete points to form an optimized pocket milling machining tool path.

In an embodiment, the calculating the feeding speed of each motion axis at each of the discrete tool position points includes following steps:
3.1) for the pocket milling tool path, which belongs to three-axis machining, only the X and Y motion axes are involved in the machining process, so only the X and Y motion directions are considered when calculating the feeding speed at each of the discrete tool position points;
3.2) assuming uniform motion at a set feeding speed during feeding speed calculation, and denoting the feeding speed as V_{F};
3.3) calculating a time interval Δt=ΔS/V_{F} between adjacent discrete points according to a discrete spacing ΔS;
3.4) the theoretical feeding speeds vₓ(i), v_{y}(i) of X-axis and Y-axis at an i-th discrete point being expressed by following formula:

$$\{ \begin{matrix}{v}_{x} ( i ) = ( {X}_{i} - {X}_{i - 1} ) / Δ t \\ {v}_{y} ( i ) = ( {Y}_{i} - {Y}_{i - 1} ) / Δ t\end{matrix} \{ i = 1 , 2 , … , n \} ,$$

where Xᵢ is an axis coordinate of the i-th discrete point, Yᵢ is a Y-axis coordinate of the i-th discrete point, and n is a number of discrete points; and
3.5) drawing feeding speed curves of the pocket machining tool path in the X-axis and Y-axis directions according to the calculated feeding speeds in the X-axis and Y-axis directions at each discrete point.

In an embodiment, the smoothing the feeding speed variation curve of the tool path through the Gaussian filter includes following steps:
4.1) selecting the Gaussian filter and determining filter parameters;
4.2) calculating time required for the machine tool to accelerate from rest to the given feeding speed;
4.3) determining a cut-off wavelength of the filter;
4.4) calculating a feeding speed curve through a convolution formula.

In an embodiment, the recalculating new tool position points according to the feeding speed of each discrete point on the smoothed feeding speed curve includes:
calculating each discrete point according to a new feeding speed, and obtaining an X-axis coordinate Qₓ(i) and a Y-axis coordinate Q_{y}(i) of new tool position points through following formula:

$$\{ \begin{matrix}{Q}_{x} ( i ) = {Q}_{x} ( i - 1 ) + {v}_{x}^{′} ( i ) \times Δ t \\ {Q}_{y} ( i ) = {Q}_{y} ( i - 1 ) + {v}_{y}^{′} ( i ) \times Δ {t}^{′}\end{matrix}$$

$$where {v}_{x}^{′} ( i )$$

is a feeding speed of filtered i-th discrete point in the X-axis direction, and

$${v}_{y}^{′} ( i )$$

is a feeding speed of the filtered i-th discrete point in the Y-axis direction.

In an embodiment, the Gaussian filter is expressed by following formula:

$$s ( u ) = \frac{1}{{αλ}_{c}} exp [ - {π ( \frac{u}{{αλ}_{c}} )}^{2} ] ,$$

where u represents a relative position from a center of a weighting function curve, λ_{c} is the cut-off wavelength of the filter, and α is calculated by following formula:

$$α = \sqrt{\frac{ln 2}{π}} = 0.4697 .$$

In an embodiment, the calculating the time required for the machine tool to accelerate from rest to the given feeding speed includes:
for the pocket milling tool path, accelerating or decelerating according to a S-curve acceleration and deceleration control mode during machining, and obtaining the time Tmin required for the machine tool to accelerate from rest to the given feeding speed V_{F}:

$${T}_{min} = \frac{{A}_{max}}{{J}_{max}} \times 2 + ( {V}_{F} - \frac{{A}_{max}^{2}}{{J}_{max}} ) / {A}_{max} ,$$

where Aₘₐₓ is a maximum acceleration of a certain motion axis of the machine tool, and Jₘₐₓ is a maximum jerk of a certain motion axis of the machine tool; and
in response to that

$$( {V}_{F} - \frac{A {2}_{max}}{{J}_{max}} < 0 ) ,$$

decelerating acceleration before reaching a maximum value, where corresponding acceleration time is calculated by following formula:

$$T {\sqrt{\frac{{V}_{F}}{{J}_{max}}}}_{min} .$$

In an embodiment, the cut-off wavelength of the filter is calculated by:
time required for the feeding speed to drop from a given value to 0 is also Tmin, and 2Tmin is taken as the cut-off wavelength λ_{c} in the Gaussian filter, that is, a severe feeding speed transition change within the acceleration and deceleration reaction time of 2Tmin is filtered out to smooth the feeding speed curve, and the cut-off wavelength λ_{c} is calculated by following formula:

$${λ}_{c} = \{ \begin{matrix}2 \sqrt{\frac{{V}_{F}}{{J}_{max}}} , & ( {V}_{F} - \frac{{A}_{max}^{2}}{{J}_{max}} ) < 0 \\ \frac{4 {A}_{max}}{{J}_{max}} + \frac{2 ( {V}_{F} - \frac{{A}_{max}^{2}}{{J}_{max}} )}{{A}_{max}} , & ( {V}_{F} - \frac{{A}_{max}^{2}}{{J}_{max}} ) \geq 0\end{matrix} .$$

In an embodiment, the calculating the feeding speed curve through the convolution formula includes:
calculating a filtered feeding speed through the convolution formula,
where a filtered feeding speed curve p(t) is calculated by following formula:

$$p ( t ) = {\int }_{- ∞}^{+ ∞} c ( ε ) s ( t - ε ) d ε = {\int }_{- ∞}^{+ ∞} c ( t - ε ) s ( ε ) d ε ,$$

ε is a time parameter of a theoretical feeding speed curve, c(ε) is a theoretical feeding speed curve composed of a series of discrete points, t=kΔt, (k=0, 1, . . . , n−1), n represents a number of discrete points, and a feeding speed at each discrete point after filtering is calculated by following formula:

$$\{ \begin{matrix}p ( i ) = {\sum }_{k = - m}^{m} {c}_{i - k} {s}_{k} , ( i = m , … , n - m ) \\ {s}_{k} = \frac{Δ t}{{αλ}_{c}} exp [ - {π ( \frac{k Δ t}{{αλ}_{c}} )}^{2} ]\end{matrix} ;$$

i represents the filtered i-th discrete point; p(i) represents a feeding speed at the filtered i-th discrete point; cᵢ₋ₖ represents a theoretical feeding speed at a filtered (i-k)-th discrete point, λ_{c}>50Δt, a filtering parameter m is an interaction range parameter of each discrete point during convolution calculation, and m is calculated by an empirical formula:

$$m = int ( 0.85 \times \frac{{λ}_{c}}{Δ t} ) .$$

The present application fully quantitatively analyzes the machine tool dynamic response capability, optimizes the machining tool path based on machine tool dynamic characteristics, and provides a method based on digital filtering to smooth the feeding speed variation curves of each axis of the machine tool during movement, thereby directly reducing the feeding speed reduction of the machine tool. By reducing feeding speed reduction, the pocket milling machining efficiency is improved, and the pocket machining tool path is made smoother and more adaptable to the acceleration and deceleration characteristics of the machine tool.

### BRIEF DESCRIPTION OF THE DRAWINGS

FIG. 1 is a flow chart of a pocket milling tool path optimization method based on digital filtering.

FIG. 2 is a typical pocket feature of an aircraft structural part.

FIG. 3 is a machining tool path before optimization.

FIG. 4 is a discrete tool position point of the tool path before optimization.

FIG. 5 is a feeding speed curve of the machining tool path shown in FIG. 3 and FIG. 4 on X-axis before optimization.

FIG. 6 is a feeding speed curve of the machining tool path shown in FIG. 3 and FIG. 4 on Y-axis before optimization.

FIG. 7 is a feeding speed curve of the machining tool path shown in FIG. 3 and FIG. 4 on X-axis after optimization.

FIG. 8 is a feeding speed curve of the machining tool path shown in FIG. 3 and FIG. 4 on Y-axis after optimization.

FIG. 9 is a discrete tool position point of a recalculated machining tool path after optimization.

FIG. 10 is a recalculated machining tool path after optimization.

FIG. 11 is an aluminum alloy aircraft structural part, where P1-P4 are four pockets.

FIGS. 12 to 15 are machining tool paths of the four pockets P1-P4 shown in FIG. 11 before optimization.

FIGS. 16 to 19 are the machining tool paths of the four pockets P1-P4 shown in FIG. 11 after optimization.

FIG. 20 is a flow chart of the pocket milling tool path optimization method based on digital filtering according to an embodiment of the present application.

FIG. 21 is a flow chart of the pocket milling tool path optimization method based on digital filtering according to an embodiment of the present application.

### DETAILED DESCRIPTION OF THE EMBODIMENTS

To make the purpose, technical solution and advantages of the present application clearer, the technical solution in the embodiments of the present application will be clearly and completely described below with reference to the accompanying drawings in the embodiments of the present application. Obviously, the described embodiments are for explaining the present application rather than limiting the present application. All other embodiments obtained by those skilled in the art without creative efforts based on the embodiments of the present application belong to the scope of the present application.

The specific implementation of the present application will be described below with reference to the accompanying drawings and examples, and the present application is not limited to the embodiments.

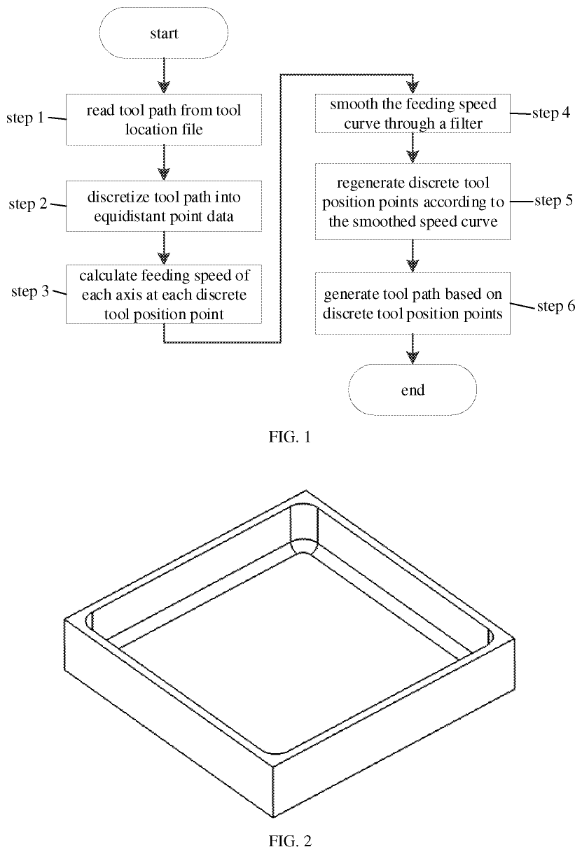

As shown in FIG. 1, a pocket milling tool path optimization method based on digital filtering includes the following steps:
step 1: reading tool path information from a pocket machining tool location file or a numerical control (NC) program;
step 2: discretizing a tool path at a constant interval ΔS along a pocket machining tool path to obtain a series of discrete tool position points;
step 3: calculating a feeding speed at each of the discrete tool position points in each motion axis direction under theoretical conditions according to a given feeding speed of a tool path, and obtaining a feeding speed variation curve of the tool path according to a feeding speed at each of the discrete tool position points;
step 4: smoothing the feeding speed variation curve of the tool path through a Gaussian filter to obtain a smoothed feeding speed curve;
step 5: recalculating new tool position points according to a feeding speed of each discrete point on the smoothed feeding speed curve; and
step 6: combining recalculated discrete points to form an optimized pocket milling machining tool path.

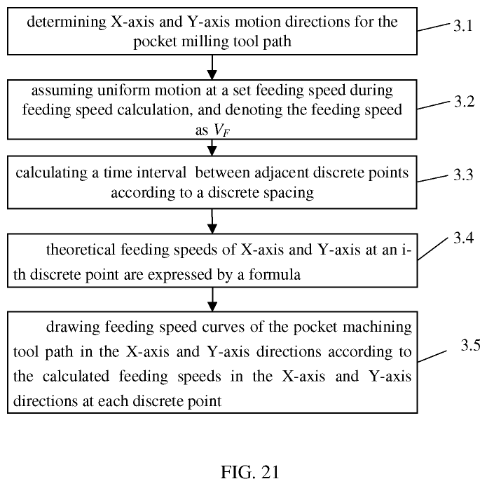

Referring to FIG. 21, the method for calculating the feeding speed of each motion axis at each of the discrete tool position points in step 3 includes the following specific steps:
3.1) for the pocket milling tool path, which belongs to three-axis machining, only the X and Y motion axes are involved in the machining process, so only the X and Y motion directions are considered when calculating the feeding speed at each of the discrete tool position points;
3.2) assuming uniform motion at a set feeding speed during feeding speed calculation, and denoting the feeding speed as V_{F};
3.3) calculating a time interval Δt=ΔS/V_{F} between adjacent discrete points according to a discrete spacing ΔS;
3.4) the theoretical feeding speeds vₓ(i), v_{y}(i) of X-axis and Y-axis at an i-th discrete point being expressed by following formula:

$$\{ \begin{matrix}{v}_{x} ( i ) = ( {X}_{i} - {X}_{i - 1} ) / Δ t \\ {v}_{y} ( i ) = ( {Y}_{i} - {Y}_{i - 1} ) / Δ t\end{matrix} \{ i = 1 , 2 , … , n \} ,$$

where Xᵢ is an axis coordinate of the i-th discrete point, Yᵢ is a Y-axis coordinate of the i-th discrete point, and n is a number of discrete points; and
3.5) drawing feeding speed curves of the pocket machining tool path in the X-axis and Y-axis directions according to the calculated feeding speeds in the X-axis and Y-axis directions at each discrete point.

Referring to FIG. 20, the method for smoothing the feeding speed variation curve of the tool path through the Gaussian filter in step 4 includes the following steps:
4.1) selecting the Gaussian filter and determining filter parameters;
4.2) calculating time required for the machine tool to accelerate from rest to the given feeding speed;
4.3) determining a cut-off wavelength of the filter;
4.4) calculating a feeding speed curve through a convolution formula.

Further, the specific method for recalculating new tool position points according to the feeding speed of each discrete point on the smoothed feeding speed curve in step 5 is as follows:
calculating each discrete point according to a new feeding speed, and obtaining an X-axis coordinate Qₓ(i) and a Y-axis coordinate Q_{y}(i) of new tool position points through following formula:

$$\{ \begin{matrix}{Q}_{x} ( i ) = {Q}_{x} ( i - 1 ) + {v}_{x}^{′} ( i ) \times Δ t \\ {Q}_{y} ( i ) = {Q}_{y} ( i - 1 ) + {v}_{y}^{′} ( i ) \times Δ t\end{matrix}$$

$$where {v}_{x}^{′} ( i )$$

is a feeding speed of filtered i-th discrete point in the X-axis direction, and

$${v}_{y}^{′} ( i )$$

is a feeding speed of the filtered i-th discrete point in the Y-axis direction.

The Gaussian filter is expressed by the following formula:

$$s ( u ) = \frac{1}{{αλ}_{c}} exp [ - {π ( \frac{u}{{αλ}_{c}} )}^{2} ] ,$$

where u represents a relative position from a center of a weighting function curve, λ_{c} is the cut-off wavelength of the filter, and a is calculated by following formula:

$$α = \sqrt{\frac{ln 2}{π}} = 0.4697 .$$

The calculation of the machine tool accelerating from rest to a given feeding speed in step 4.2) is as follows:
for a numerical control machine tool, accelerating or decelerating according to a S-curve acceleration and deceleration control mode during machining, and obtaining the time Tₘᵢₙ required for the machine tool to accelerate from rest to the given feeding speed V_{F}:

$${T}_{min} = \frac{{A}_{max}}{{J}_{max}} \times 2 + ( {V}_{F} - \frac{{A}_{max}^{2}}{{J}_{max}} ) / {A}_{max} ,$$

where Aₘₐₓ is a maximum acceleration of a certain motion axis of the machine tool, and Jₘₐₓ is a maximum jerk of a certain motion axis of the machine tool; and
in response to that

$$( {V}_{F} - \frac{A {2}_{max}}{{J}_{max}} < 0 ) ,$$

decelerating acceleration before reaching a maximum value, where corresponding acceleration time is calculated by following formula:

$$T {\sqrt{\frac{{V}_{F}}{{J}_{max}}}}_{min} .$$

The cut-off wavelength of the filter in Step 4.3) is calculated by the following:
time required for the feeding speed to drop from a given value to 0 is also Tₘᵢₙ, and 2Tₘᵢₙ is taken as the cut-off wavelength λ_{c} in the Gaussian filter, that is, a severe feeding speed transition change within the acceleration and deceleration reaction time of 2Tₘᵢₙ is filtered out to smooth the feeding speed curve, and the cut-off wavelength λ_{c} is calculated by following formula:

$${λ}_{c} = \{ \begin{matrix}2 \sqrt{\frac{{V}_{F}}{{J}_{max}}} , & ( {V}_{F} - \frac{{A}_{max}^{2}}{{J}_{max}} ) < 0 \\ \frac{4 {A}_{max}}{{J}_{max}} + \frac{2 ( {V}_{F} - \frac{{A}_{max}^{2}}{{J}_{max}} )}{{A}_{max}} , & ( {V}_{F} - \frac{{A}_{max}^{2}}{{J}_{max}} ) \geq 0\end{matrix} .$$

The calculation method of the feeding speed curve in step 4.4) is as follows:
calculating a filtered feeding speed through the convolution formula;
where a filtered feeding speed curve p(t) is calculated by following formula:

$$p ( t ) = {\int }_{- ∞}^{+ ∞} c ( ε ) s ( t - ε ) d ε = {\int }_{- ∞}^{+ ∞} c ( t - ε ) s ( ε ) d ε ,$$

ε is a time parameter of a theoretical feeding speed curve, c(ε) is a theoretical feeding speed curve composed of a series of discrete points, t=kΔt, (k=0, 1, . . . , n−1), n represents a number of discrete points, and a feeding speed at each discrete point after filtering is calculated by following formula:

$$\{ \begin{matrix}p ( i ) = {\sum }_{k = - m}^{m} {c}_{i - k} {s}_{k} , ( i = m , … , n - m ) \\ {s}_{k} = \frac{Δ t}{{αλ}_{c}} exp [ - {π ( \frac{k Δ t}{{αλ}_{c}} )}^{2} ]\end{matrix} ,$$

where i represents the filtered i-th discrete point; p(i) represents a feeding speed at the filtered i-th discrete point; cᵢ₋ₖ represents a theoretical feeding speed at a filtered (i-k)-th discrete point. When the Δt is small enough, a smooth feeding speed curve can be obtained. In order to ensure the filtering accuracy of the speed curve, λ_{c}>50Δt should be satisfied. A filtering parameter m is an interaction range parameter of each discrete point during convolution calculation, and m is calculated by an empirical formula:

$$m = int ( 0.85 \times \frac{{λ}_{c}}{Δ t} ) .$$

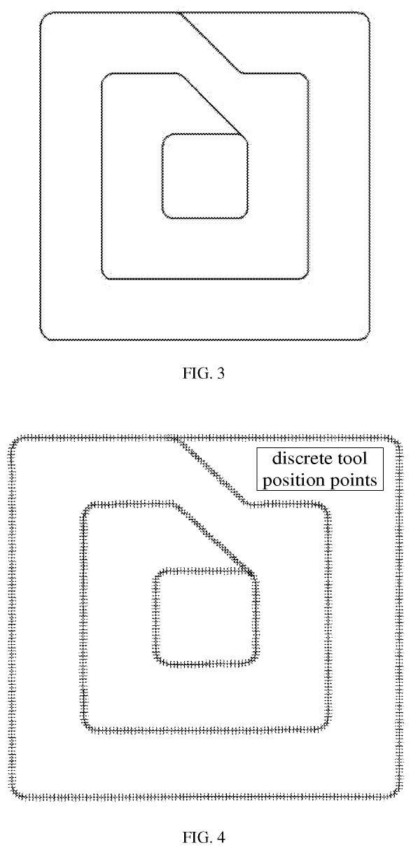

The typical pocket feature of the aircraft structural part shown in FIG. 2 is milled with a Φ20 mm cutting tool and a cutting width of 10 mm.

Step 1: reading tool path information from a pocket machining tool location file or a numerical control (NC) program, and the tool path is shown in FIG. 3;

Step 2: discretizing the machining tool path along the pocket milling tool path at a constant interval ΔS=0.2 mm to obtain a series of discrete tool position points, as shown in FIG. 4; FIG. 4 shows the tool path information read from the pocket machining tool location file or NC program, and the discrete tool location points of the tool path are displayed in FIG. 4.

Step 3: The given feeding speed of the tool path is F=3000 mm/min, i.e., V_{F}=50 mm/s, and the feeding speed at each of the discrete tool position points in each motion axis direction under theoretical conditions is calculated.

Since pocket milling belongs to three-axis machining, only the X-axis and Y-axis motion directions need to be considered when calculating the feeding speed of each discrete point; the time interval between adjacent discrete points is Δt=ΔS/V_{F}, so the theoretical feeding speeds vₓ(i) and v_{y}(i) of the X-axis and Y-axis at the i-th discrete point can be calculated by the following formulas:

$$\{ \begin{matrix}{v}_{x} ( i ) = ( {X}_{i} - {X}_{i - 1} ) / Δ t \\ {v}_{y} ( i ) = ( {Y}_{i} - {Y}_{i - 1} ) / Δ t\end{matrix} , \{ i = 1 , 2 , … , n \} .$$

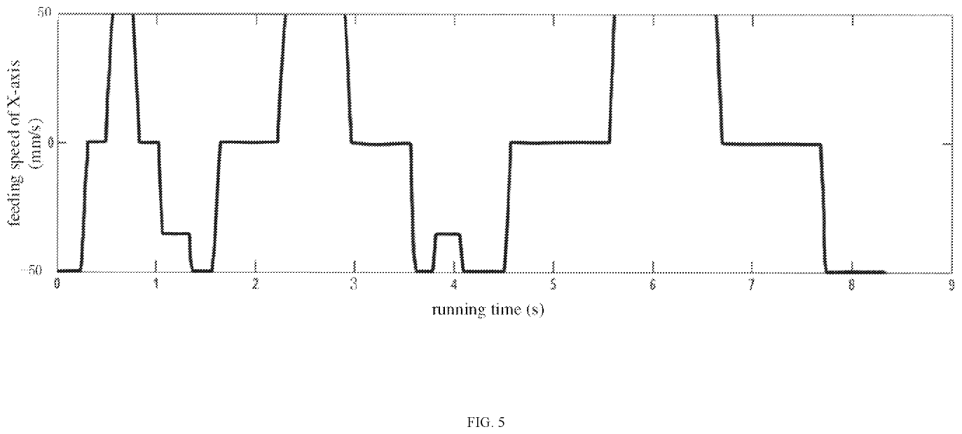

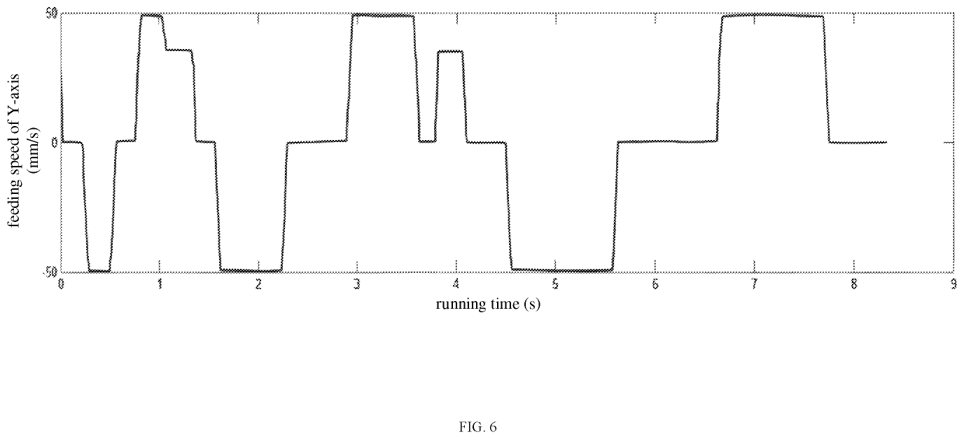

The feeding speed at each discrete point can be calculated according to the above formulas, and the tool path feeding speed curves are drawn, as shown in FIG. 5 and FIG. 6. FIG. 5 and FIG. 6 present the theoretical feeding speed at each discrete point calculated based on the proposed formulas, and the theoretical feeding speed curve of the tool path is plotted in combination with the running time. The running time in the figures refers to the elapsed time when the program runs to a certain discrete point.

Step 4: smoothing the feeding speed variation curve of the tool path through the Gaussian filter to obtain a smoothed feeding speed curve; and the Gaussian filter formula is expressed by the following formula:

$$s ( u ) = \frac{1}{{αλ}_{c}} exp [ - {π ( \frac{u}{{αλ}_{c}} )}^{2} ] ,$$

where u represents the relative position from the center of the weighting function curve, λ_{c} is one of the important parameters of the filter, i.e., the cut-off wavelength, and α is calculated by the following formula:

$$α = \sqrt{\frac{ln 2}{π}} = 0.4697 .$$

For a numerical control machine tool, it accelerates and decelerates according to the S-curve acceleration and deceleration control mode during machining. Firstly, the time Tₘᵢₙ required for the machine tool to accelerate from rest to the given feeding speed V_{F} is obtained:

$${T}_{min} = \frac{{A}_{max}}{{J}_{max}} \times 2 + ( {V}_{F} - \frac{{A}_{max}^{2}}{{J}_{max}} ) / {A}_{max} ,$$

where Aₘₐₓ is a maximum acceleration of a certain motion axis of the machine tool, and Jₘₐₓ is a maximum jerk of a certain motion axis of the machine tool; and
in response to that

$$( {V}_{F} - \frac{A {2}_{max}}{{J}_{max}} < 0 ) ,$$

decelerating acceleration before reaching a maximum value, where corresponding acceleration time is calculated by following formula:

$$T {\sqrt{\frac{{V}_{F}}{{J}_{max}}}}_{min} .$$

The time required for the feeding speed to drop from the given value to 0 is also Tₘᵢₙ, so 2Tₘᵢₙ is taken as the cut-off wavelength λ_{c} in the Gaussian filter, that is, the severe feeding speed transition change within the acceleration and deceleration reaction time of 2Tₘᵢₙ is filtered out to smooth the feeding speed curve. The cut-off wavelength λ_{c} can be calculated by the following formula:

$${λ}_{c} = \{ \begin{matrix}2 \sqrt{\frac{{V}_{F}}{{J}_{max}}} , & ( {V}_{F} - \frac{{A}_{max}^{2}}{{J}_{max}} ) < 0 \\ \frac{4 {A}_{max}}{{J}_{max}} + \frac{2 ( {V}_{F} - \frac{{A}_{max}^{2}}{{J}_{max}} )}{{A}_{max}} , & ( {V}_{F} - \frac{{A}_{max}^{2}}{{J}_{max}} ) \geq 0\end{matrix} .$$

The filtered feeding speed is calculated through a convolution formula. The filtered feeding speed curve p(t) can be calculated by the following formula, where c(ε) is the theoretical feeding speed curve:

$$p ( t ) = {\int }_{- ∞}^{+ ∞} c ( ε ) s ( t - ε ) d ε = {\int }_{- ∞}^{+ ∞} c ( t - ε ) s ( ε ) d ε .$$

The theoretical feeding speed curve is composed of a series of discrete points, namely, t=kΔt, (k=0, 1, . . . , n−1), so the feeding speed at each discrete point after filtering can be calculated by the following formula:

$$\{ \begin{matrix}p ( i ) = {\sum }_{k = - m}^{m} {c}_{i - k} {s}_{k} , ( i = m , … , n - m ) \\ {s}_{k} = \frac{Δ t}{{αλ}_{c}} exp [ - {π ( \frac{k Δ t}{{αλ}_{c}} )}^{2} ]\end{matrix} .$$

When Δt is sufficiently small, a smooth feeding speed curve is obtained. To ensure the filtering accuracy of the feeding speed curve, λ_{c}>504t should be satisfied. In addition, the filtering parameter m is the interaction range parameter of each discrete point during convolution calculation. The larger m is, the higher the accuracy is, but the corresponding computational efficiency is reduced. Generally, m can be calculated by an empirical formula:

$$m = int ( 0.85 \times \frac{{λ}_{c}}{Δ t} ) .$$

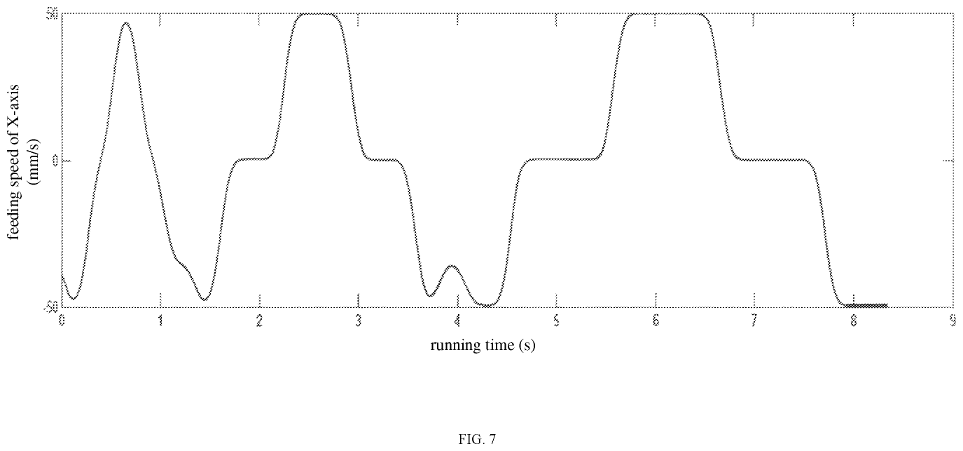

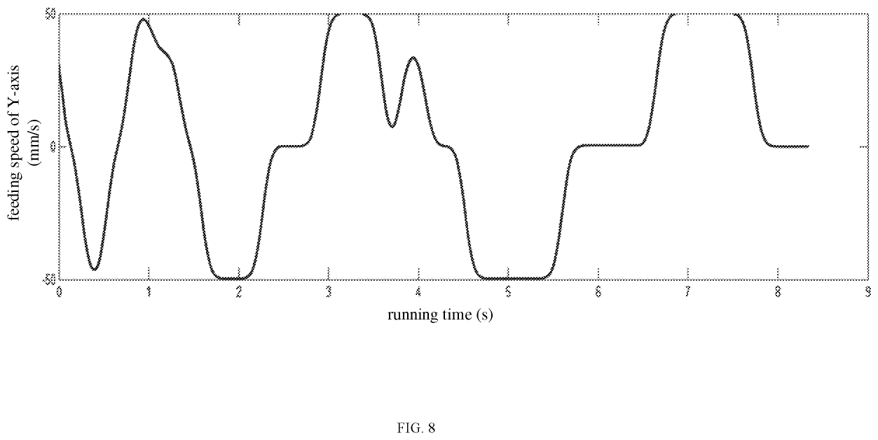

For the machine tool used for machining the pocket feature shown in FIG. 2, Jmax=5 m/s3, Amax=0.5 m/s3, the cut-off wavelength λ_{c}=0.2s and Δt=0.004s can be calculated, and the filtered feeding speed curves are obtained as shown in FIG. 7 and FIG. 8.

Step 5: recalculating new tool position points according to a feeding speed of each discrete point on the smoothed feeding speed curve.

Each discrete point is calculated according to the new feeding speed, and the X-axis coordinate Qₓ(i) and Y-axis coordinate Q_{y}(i) of the new tool position points be calculated by the following formulas:

$$\{ \begin{matrix}{Q}_{x} ( i ) = {Q}_{x} ( i - 1 ) + {v}_{x}^{′} ( i ) \times Δ t \\ {Q}_{y} ( i ) = {Q}_{y} ( i - 1 ) + {v}_{y}^{′} ( i ) \times Δ t\end{matrix} ,$$

$$where {v}_{x}^{′} ( i )$$

is a feeding speed of filtered i-th discrete point in the X-axis direction, and

$${v}_{y}^{′} ( i )$$

is a feeding speed of the filtered i-th discrete point in the Y-axis direction

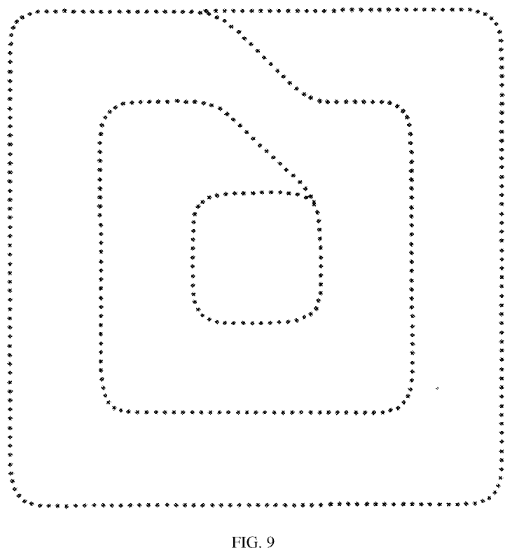

The filtered discrete points are obtained through the above calculation, as shown in FIG. 9.

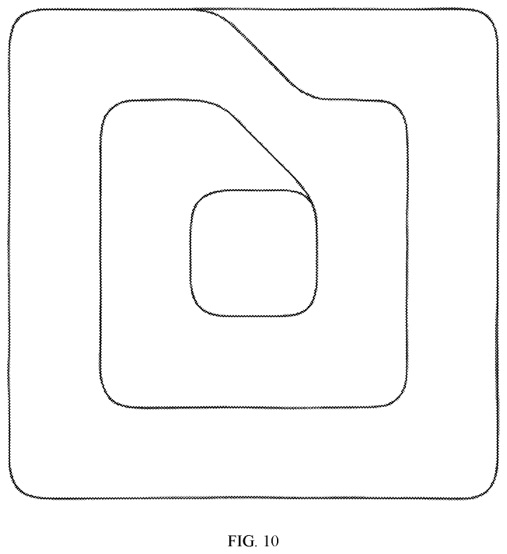

Step 6: combining recalculated discrete points to form an optimized pocket milling machining tool path, as shown in FIG. 10.

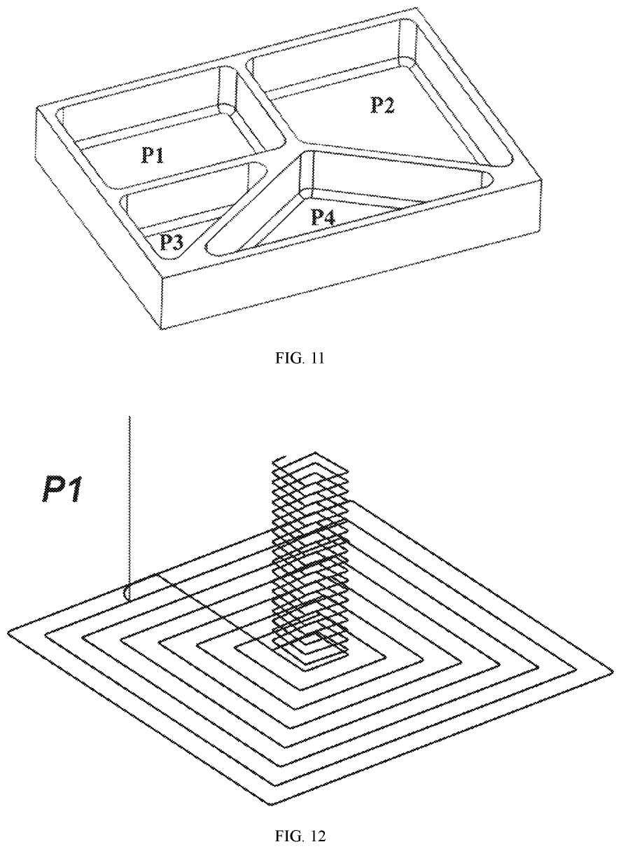

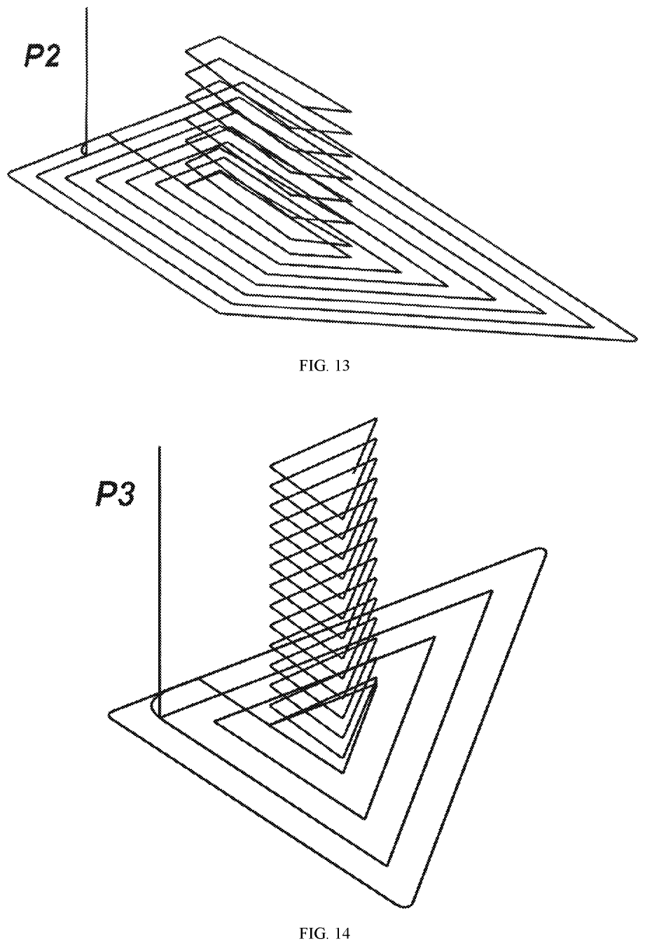

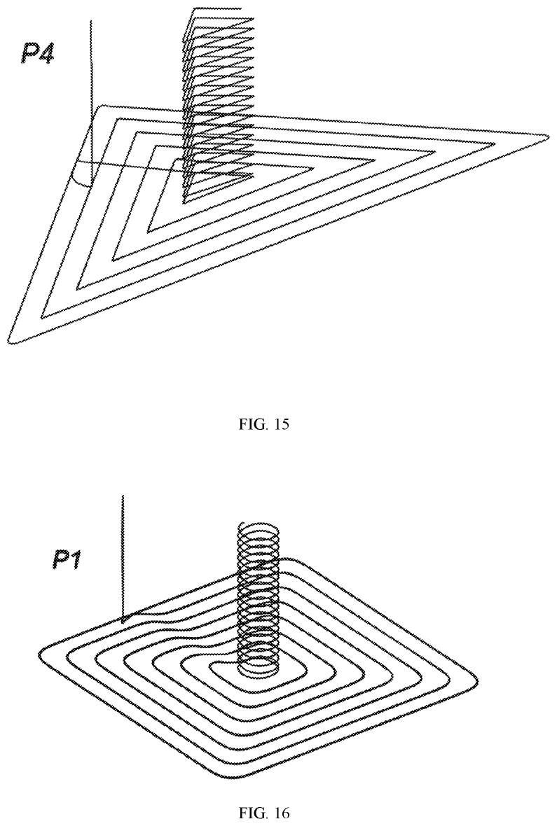

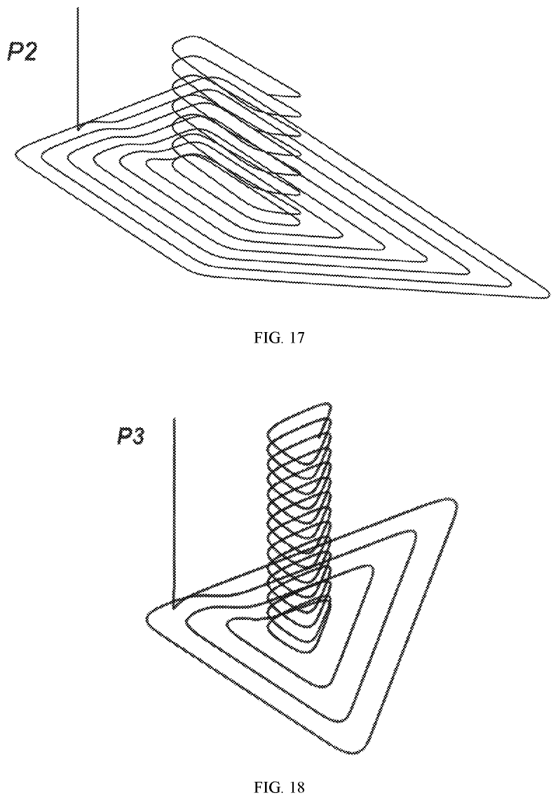

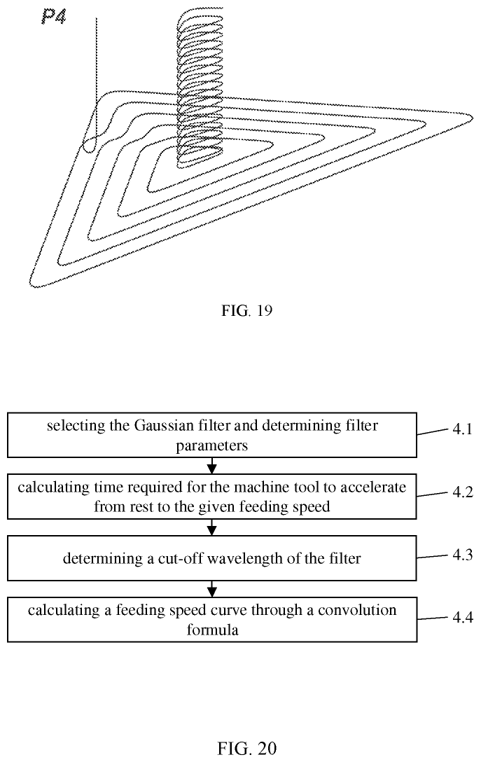

For the pocket features P1-P4 of the aluminum alloy structural part shown in FIG. 11, the traditional unoptimized pocket milling machining tool paths are shown in FIG. 12, FIG. 13, FIG. 14 and FIG. 15. The tool paths optimized by the method of the present application are shown in FIG. 16, FIG. 17, FIG. 18 and FIG. 19. The optimized tool paths are smooth, avoiding frequent acceleration and deceleration of the machine tool during machining. The machining time of the pocket milling tool paths before and after optimization is compared as shown in Table 1 below, and the machining time is reduced by 18.75% on average, which can effectively improve machining efficiency.

TABLE 1

| | machining time/s | | time |
|---|---|---|---|
| pocket No. | unoptimized tool path | optimized tool path | savings (%) |
| P1 | 23 | 18 | 21.70% |
| P2 | 27 | 22 | 18.50% |
| P3 | 32 | 28 | 12.50% |
| P4 | 30 | 23 | 23.30% |

The above descriptions are only embodiments of the present application and are not intended to limit the present application. Any modifications, equivalent replacements, improvements and the like made within the spirit and principles of the present application shall be included in the scope of the present application.

What is claimed is:

1. A pocket milling tool path optimization method based on digital filtering, comprising following steps:
step 1: reading tool path information from a pocket machining tool location file or a numerical control (NC) program;
step 2: discretizing a tool path at a constant interval ΔS along a pocket machining tool path to obtain a series of discrete tool position points;
step 3: calculating a feeding speed at each of the discrete tool position points in each motion axis direction under theoretical conditions according to a given feeding speed of a tool path, and obtaining a feeding speed variation curve of the tool path according to a feeding speed at each of the discrete tool position points;
step 4: smoothing the feeding speed variation curve of the tool path through a Gaussian filter to obtain a smoothed feeding speed curve;
step 5: recalculating new tool position points according to a feeding speed of each discrete point on the smoothed feeding speed curve; and
step 6: combining recalculated discrete points to form an optimized pocket milling machining tool path;
wherein the smoothing the feeding speed variation curve of the tool path through the Gaussian filter in step 4 comprises following steps:
4.1) selecting the Gaussian filter and determining filter parameters;
4.2) calculating time required for the machine tool to accelerate from rest to the given feeding speed;
4.3) determining a cut-off wavelength of the filter; and
4.4) calculating a feeding speed curve through a convolution formula.

2. The pocket milling tool path optimization method based on digital filtering according to claim 1, wherein the calculating the feeding speed of each motion axis at each of the discrete tool position points in step 3 comprises following steps:
3.1) determining X-axis and Y-axis motion directions for the pocket milling tool path;
3.2) assuming uniform motion at a set feeding speed during feeding speed calculation, and denoting the feeding speed as V_{F};
3.3) calculating a time interval Δt=ΔS/V_{F} between adjacent discrete points according to a discrete spacing ΔS;
3.4) theoretical feeding speeds vₓ(i), v_{y}(i) of X-axis and Y-axis at an i-th discrete point being expressed by following formula:
$$\{ \begin{matrix}{v}_{x} ( i ) = ( {X}_{i} - {X}_{i - 1} ) / Δ t \\ {v}_{y} ( i ) = ( {Y}_{i} - {Y}_{i - 1} ) / Δ t\end{matrix} \{ i = 1 , 2 , … n \} ,$$
wherein Xᵢ is an axis coordinate of the i-th discrete point, Yᵢ is a Y-axis coordinate of the i-th discrete point, and n is a number of discrete points; and
3.5) drawing feeding speed curves of the pocket machining tool path in the X-axis and Y-axis directions according to the calculated feeding speeds in the X-axis and Y-axis directions at each discrete point.

3. The pocket milling tool path optimization method based on digital filtering according to claim 1, wherein the recalculating new tool position points according to the feeding speed of each discrete point on the smoothed feeding speed curve in step 5 comprises:
calculating each discrete point according to a new feeding speed, and obtaining an X-axis coordinate Qₓ(i) and a Y-axis coordinate Q_{y}(i) of new tool position points through following formula:
$$\{ \begin{matrix}{Q}_{x} ( i ) = {Q}_{x} ( i - 1 ) + {v}_{x}^{′} ( i ) \times Δ t \\ {Q}_{y} ( i ) = {Q}_{y} ( i - 1 ) + {v}_{y}^{′} ( i ) \times Δ t\end{matrix} ,$$
$$wherein {v}_{x}^{′} ( i )$$
is a feeding speed of filtered i-th discrete point in the X-axis direction, and
$${v}_{y}^{′} ( i )$$
is a feeding speed of the filtered i-th discrete point in the Y-axis direction.

4. The pocket milling tool path optimization method based on digital filtering according to claim 1, wherein the Gaussian filter is expressed by following formula:
$$s ( u ) = \frac{1}{{αλ}_{c}} exp [ - {π ( \frac{u}{{αλ}_{c}} )}^{2} ] ,$$
wherein u represents a relative position from a center of a weighting function curve, λ_{c} is the cut-off wavelength of the filter, and α is calculated by following formula:
$$α = \sqrt{\frac{ln 2}{π}} .$$

5. The pocket milling tool path optimization method based on digital filtering according to claim 4, wherein the calculating the time required for the machine tool to accelerate from rest to the given feeding speed in step 4.2) comprises:
accelerating or decelerating according to a S-curve acceleration and deceleration control mode during machining, and obtaining the time Tₘᵢₙ required for the machine tool to accelerate from rest to the given feeding speed V_{F}:
$${T}_{min} = \frac{{A}_{max}}{{J}_{max}} \times 2 + ( {V}_{F} - \frac{{A}_{max}^{2}}{{J}_{max}} ) / {A}_{max} ,$$
wherein Aₘₐₓ is a maximum acceleration of a certain motion axis of the machine tool, and Jₘₐₓ is a maximum jerk of a certain motion axis of the machine tool; and
in response to that
$$( {V}_{F} - \frac{A {2}_{max}}{{J}_{max}} < 0 ) ,$$
decelerating acceleration before reaching a maximum value, wherein corresponding acceleration time is calculated by following formula:
$$T {\sqrt{\frac{{V}_{F}}{{J}_{max}}}}_{min} .$$

6. The pocket milling tool path optimization method based on digital filtering according to claim 5, wherein the cut-off wavelength of the filter in 4.3) is calculated by:
time required for the feeding speed to drop from a given value to 0 being also Tₘᵢₙ, and 2Tₘᵢₙ being taken as the cut-off wavelength λ_{c} in the Gaussian filter, that is, a severe feeding speed transition change within the acceleration and deceleration reaction time of 2Tₘᵢₙ being filtered out to smooth the feeding speed curve, and the cut-off wavelength λ_{c} being calculated by following formula:
$${λ}_{c} = \{ \begin{matrix}2 \sqrt{\frac{{V}_{F}}{{J}_{max}}} , & ( {V}_{F} - \frac{{A}_{max}^{2}}{{J}_{max}} ) < 0 \\ \frac{4 {A}_{max}}{{J}_{max}} + \frac{2 ( {V}_{F} - \frac{{A}_{max}^{2}}{{J}_{max}} )}{{A}_{max}} , & ( {V}_{F} - \frac{{A}_{max}^{2}}{{J}_{max}} ) \geq 0\end{matrix} .$$

7. The pocket milling tool path optimization method based on digital filtering according to claim 6, wherein the calculating the feeding speed curve in 4.4) comprises:
calculating a filtered feeding speed through the convolution formula,
wherein a filtered feeding speed curve p(t) is calculated by following formula:
$$p ( t ) = {\int }_{- ∞}^{+ ∞} c ( ε ) s ( t - ε ) d ε = {\int }_{- ∞}^{+ ∞} c ( t - ε ) s ( ε ) d ε ,$$
ε is a time parameter of a theoretical feeding speed curve, c(ε) is a theoretical feeding speed curve composed of a series of discrete points, t=kΔt, (k=0, 1, . . . , n−1), n represents a number of discrete points, and a feeding speed at each discrete point after filtering is calculated by following formula:
$$\{ \begin{matrix}p ( i ) = {\sum }_{k = - m}^{m} {c}_{i - k} {s}_{k} , ( i = m , … , n - m ) \\ {s}_{k} = \frac{Δ t}{{αλ}_{c}} exp [ - {π ( \frac{k Δ t}{{αλ}_{c}} )}^{2} ]\end{matrix} ;$$
wherein, i represents the filtered i-th discrete point; p(i) represents a feeding speed at the filtered i-th discrete point; cᵢ₋ₖ represents a theoretical feeding speed at a filtered (i-k)-th discrete point, λ_{c}>50Δt, a filtering parameter m is an interaction range parameter of each discrete point during convolution calculation, and m is calculated by an empirical formula:
$$m = int ( 0.85 \times \frac{{λ}_{c}}{Δ t} ) .$$
